(19) United States
(12) Patent Application Publication
(10) Pub. No.: US 2010/0122054 A1
(43) Pub. Date: May 13, 2010

(54) COPY SAFE STORAGE

(75) Inventors: Eitan MARDIKS, Ra'anana, IL (US); Mishael Agami, Netanya, IL (US)

Correspondence Address: BRINKS HOFER GILSON & LIONE/SanDisk, P.O. BOX 10395, CHICAGO, IL, 60610, US

(73) Assignee: SanDisk IL Ltd., Kfar Saba, IL (US)

(21) Appl. No.: 12/269,075

(22) Filed: Nov. 12, 2008

(51) Int. Cl. G06F 12/14

(52) U.S. Cl. 711/163; 726/26; 711/E12.091

(57) ABSTRACT

A data storage device provides information to an application while protecting the information from being copied. Particularly, the data storage device may include a detector to detect an access to an indicator. The indictor may be integrated with the information in such a way that a copy application will access the indicator when copying the information but another application using the information (e.g. a database application) will not access the indicator. The data storage device may further be configured to undertake a defensive response when access to the indicator is detected. Defensive responses may include terminating the access, issuing a report, or sending spurious data to the host. The configuration of the indicator and timing of the response may be chosen to impede separation of the indicator from the data.

### FIELD AND BACKGROUND OF THE INVENTION

Various methods and systems for discouraging the copying of protected information are possible, and particularly, methods and systems may allow an intended application free use of protected information while preventing copying of the information.

Methods by which owners of copyrighted digital information manage (“digital rights management”) and protect (‘digital rights protection’) access to their information are well known in the art. Digital rights protection, as discussed herein, relates to protecting access to information stored in a storage device that is operationally installed or operationally connected to a computing system that is referred to herein as the “host” of the storage device. All known methods of digital rights protection require adjustment of the host to enable the use of the protected content and or require that the data-controller of the storage device know the location of the protected information and monitor activity of the host in regards to the protected information.

For example, the host might need to have special software installed (e.g. encryption/decryption software) in order to read the protected information and then the host needs to know to which files to apply what protection/decryption methodology. Such a methodology limits the population of users of the information and also opens the possibilities of a hacker attacking the software of the host to access or damage the information or the host. Furthermore, developing of software that may access the information is made difficult by the need to include special security software and to protect the application itself from hackers.

Otherwise a storage controller may monitor a host's access to particular blocks of information and act to prevent access when the host performs a prohibited activity (e.g. accessing too many blocks in a set time period or accessing the blocks in a prohibited order). Such a system requires a sophisticated storage controller increasing the cost of the device. Also such a system requires reprogramming of the storage controller when the protected information is changed. This limits the possibility of a third party adding to or updating the protected information.

There is thus a widely recognized need for, and it would be highly advantageous to have a simple storage device that transparently can supply information to a host and allow modifications of information while preventing copying of the information.

### SUMMARY OF THE INVENTION

Various methods and systems are possible for providing information to a host while protecting the information from copying. Particularly, a system or method may make information available to an application while preventing copying of the information. Methods for copy prevention may be integrated with prior art methods of digital rights management.

An embodiment of a data storage device for storing information and protecting the information from being copied may include a memory configured for storing the information and an indicator. The indicator may be integrated with the information in such a way that when the information is copied, a copy application may not differentiate the indicator from the information and the copy routine will access the indicator (for example the indicator may be copied along with the information). The device may also include a detector for detecting an access to the indicator.

The embodiment of a data storage device for storing and protecting information may further include a response module for undertaking a defensive response associated with the detecting of access to the indicator.

In the embodiment of a data storage device for storing and protecting information the defensive response may includes one or more of terminating access to the data storage device, disabling the data storage device, erasing at least a portion (some or all) of the data in the data storage device, modifying some or all of the data on the data storage device, erasing part or all of the protected information, issuing a report of the accessing and sending spurious data to a host instead of the real data. The defensive response may be activated after a random delay from the detection to make it harder to identify the location of the indicator.

In the embodiment of a data storage device for storing and protecting information the response module may a memory or an actuator.

In the embodiment of a data storage device for storing and protecting information, the indicator may include multiple indicators. The response module may be configured to undertake a first defensive response upon detection of a first indicator and a second defensive response upon detection of a second indicator. The response module may be configured to respond upon detection of a combination of indicators and the response may depend on the number or order in which the indicators were detected.

In the embodiment of a data storage device for storing and protecting information, the detector may include a CPU and a memory.

In the embodiment of a data storage device for storing and protecting information the indicator is preferably a block of data configured to appear similar to the real data and may include one or more of the following features that allow the detector to detect the indicator: having a trigger CRC value and containing a trigger pattern.

In the embodiment of a data storage device for storing and protecting information the indicator may be configured to impede separation of the indicator from the information. For example, the indicator may be configured to appear similar to the information making it hard to distinguish the indicator from the information. The indicator may also be stored in a location that makes it difficult for a copy program to access the information without accessing the indicator; it may nevertheless remain possible for an application to access the information without accessing the indicator.

In the embodiment of a data storage device for storing and protecting information the detector may include hardware or software or firmware, or a combination of hardware and/or firmware and/or software components.

The embodiment of a data storage device for storing and protecting information may further include a standard interface (which may include one or more of standard software, standard hardware, a conventional file system and a standard communication protocol) for communication (communication may include for example uploading or downloading the information) with a host.

In the embodiment of a data storage device for storing and protecting information, there may be a plurality of indicators.

An embodiment of a method of providing information to a host and of preventing copying of the information may include integrating an indicator with the information and storing the indicator on a data storage device configured to undertake a defensive response upon access to the indicator.

In the embodiment of a method for providing information and preventing copying of the information the indicator may include one or more of a trigger CRC value, a trigger attribute and a trigger pattern.

The method of providing information to a host and of preventing copying of the information may further include arranging the information and the indicator so that the information is available to an application and the indicator is inaccessible to the application.

In the embodiment of a method for providing information and preventing copying of the information the application may be database application, a graphics rendering application, a game, a digital phone book application, a digital dictionary application, a digital encyclopedia application, a digital reference book application or a navigation application.

In the embodiment of a method for providing information and preventing copying of the information the undertaking of a defensive response may include one or more of terminating access of the host to a memory containing the information, issuing a report of the accessing, erasing all or part of the information, disabling a memory containing the information, erasing some or all of the data in a memory containing the information, modifying all or part of the information and sending spurious data to the host.

In the embodiment of a method for providing information and preventing copying of information the undertaking a defensive response may be delayed.

The embodiment of a method for providing information and preventing copying of the information may further include configuring the indicator to impede separation of the indicator from the information.

The embodiment of a method for providing information and preventing copying of the information may further include supplying a standard interface for communication with the host.

In the embodiment of a method for providing information and preventing copying of the information there may be multiple indicators. Undertaking a defensive response may depend on which indicator was accessed. Particularly, a first defensive response may be taken upon detection of a first indicator and a second defensive response may be taken upon detection of a second indicator of the plurality of indicators.

### BRIEF DESCRIPTION OF THE DRAWINGS

Various embodiments of a system and method for providing information to a host and protecting the information from copying are herein described, by way of example only, with reference to the accompanying drawings, where:

FIG. 1 is a high-level schematic block diagram of a data storage device for storing information and protecting the information from copying;

FIG. 2 shows a data storage device for storing information and protecting the information from copying operationally coupled to a host thereof;

FIG. 3 is a generalized flowchart of a method of providing information to a host and protecting the information from copying.

FIG. 4 is a high-level schematic block diagram showing details of a storage controller.

### DESCRIPTION OF THE PREFERRED EMBODIMENTS

The principles and operation of a copy safe storage database for protecting of data from copying according to various embodiments may be better understood with reference to the drawings and the accompanying description.

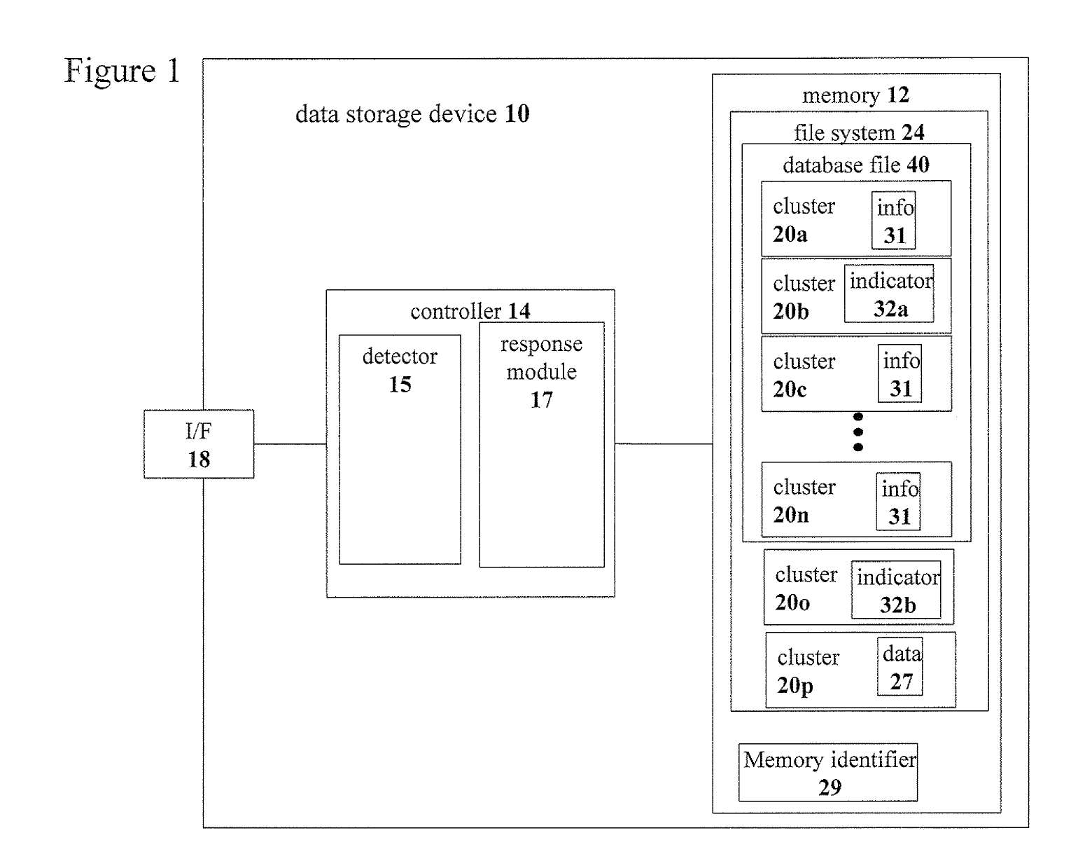

Referring now to the drawings, FIG. 1 is a high-level schematic block diagram of a data storage device 10. Data storage device 10 includes a nonvolatile memory 12, a controller 14 of memory 12 and an interface 18. Memory 12 may be any kind of nonvolatile memory but typically is a flash memory. In memory 12 is stored information 31, for example a database file 40 including clusters 20a through 20n. For example, a map provider can provide set of maps in a storage device where a navigation application can use some or all of the maps as long as database file 40 is stored on data storage device 10.

In data storage device 10, database file 40 may be stored in a conventional file system 24, such as the FAT file system of Microsoft or the NTFS file system of Microsoft, that describe how database file 40 is stored in memory 12. Controller 14 manages memory 12 in the conventional manner. For example, if memory 12 is a flash memory, controller 14 may operate, as is known in the prior art, to present memory 12 to a host of data storage device 10 as a block device.

Database file 40 includes protected information 31 in clusters 20a and 20c-n [In the embodiment of FIG. 1, the term “protected information” means information that is protected from at least one known means of copying. The information may be susceptible to other means of copying and the information is not necessarily protected from damage, corruption, infection, other forms of reproduction or malicious decoding]. Protected information 31 is freely available to applications, but is protected from copying as will be understood from the detailed description of the embodiment of storage device 10 herein below.

An indicator 32a is stored in cluster 20b. It will be understood by one skilled in the art, that although all of the useful information of database file 40 (e.g. protected information 31) is contained in clusters 20a and 20c-n (as a result it is unnecessary for a user to read cluster 20b in order to access all the useful information in database file 40), nevertheless, storing indicator 32a in database file 40 is an example of integrating indicator 32a with protected information 31 because indicator 32a and protected information 31 are both stored in database file 40

Controller 14 also contains a detector 15 and a response module 17. In the embodiment of data storage device 10, both detector 15 and response module 17 are hardware devices. Particularly, detector 15 is an integrated circuit configured to send a signal to response module 17 upon detection of indicator 32a,b. Response module 17 is an integrated circuit configured to undertake a defensive response upon receiving a signal from detector 15.

For example indicator 32a may be simulated data having a predefined trigger CRC value (or some other predetermined trigger attribute similar to a CRC value). Detector 15 may be configured to calculate the CRC value (or similar calculation) for each cluster read from memory 12 and compare the value to the predefined trigger value. Upon detecting the predefined trigger value detector 15 may then send a signal to response module 17 and response module 17 may then undertake a defensive response (for example blocking access to memory 12).

Alternatively indicator 32a may contain a trigger pattern (a particular predefined pattern of data bits) or a watermark recognizable to detector 15.

Alternatively, detector 15 may be configurable so that a distributor may configure device 10 to detect and respond to one of many indicators. Also the detector 15 may be capable of detecting several different indicators for example indicator 32a and indicator 32b. Furthermore, detector 15 may be capable of sending several different signals to response module 17. Response module 17 may also be configurable and response module 17 may also be capable of several different defensive responses. For example in the embodiment of FIG. 1 detector 15 sends a first signal to response module 17 upon detection of indicator 32a and response module 17 responds to the first signal by erasing or modifying (modifying may include for example adding spurious bits, removing the bits or rearranging bis of the data to obstruct access to the data) all or part of protected information 31 (or alternatively all of database file 40). On the other hand upon detection of indicator 32b, detector 15 sends an alternate signal to response module 17 and response module 17 may respond to the alternate signal by erasing or modifying the entire contents of memory 12 (also damaging for example a user file [e.g. data 27 stored in cluster 20p] or identification codes [for example special identification code 29] that may be in memory (12) or by erasing a portion of the data in memory 12 (for example all of data associated with files. In the example of FIG. 1 data associated with files would include clusters 20a-n and 20p but not cluster 20o (and thus not indicator 32b) and not special identification code 29.

Like the rest of controller 14, detector 15 and response module 17 in particular, may be implemented in hardware, in firmware or in software. Detector and response module hardware may be implemented on the memory controller chip or may be implemented on a separate circuit chip. Detector and response module software may be executed by controller 14 (in which case the detector and response module may be embodied entirely as software in controller 14) or by a separate component of data storage device 40.

Interface 18 may be a standard interface for interfacing data storage device 10 with its host for exchange of data. By “standard” interface is meant an interface that complies with a commonly accepted industry standard and that lacks special provision for data rights protection. Common examples of such standards include SD, compact flash, MMC and USB.

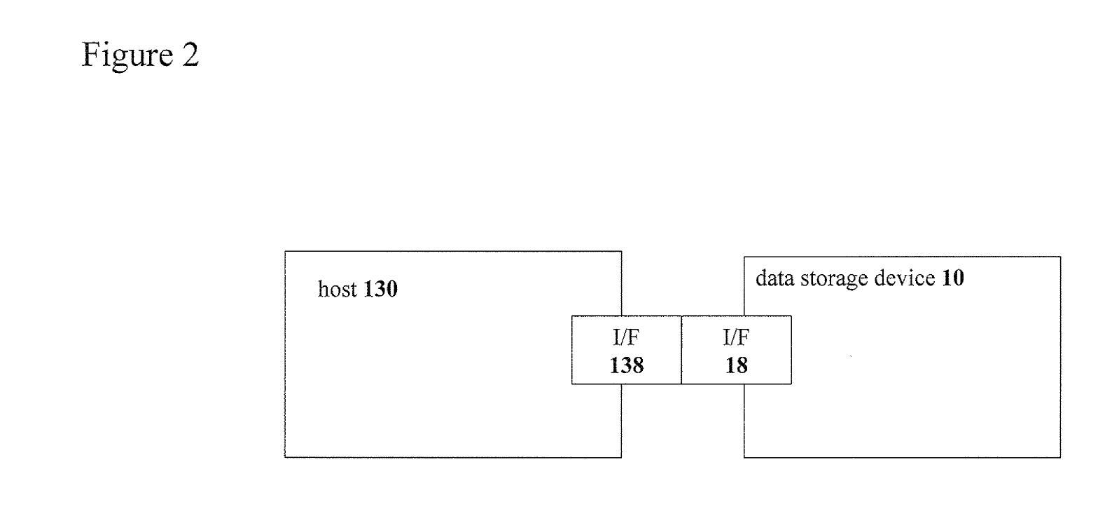

FIG. 2 shows data storage device 10 operationally connected to a host 130 via their respective interfaces 18 and 138. For example, interfaces 18 could include a standard USB plug with an appropriate standard communication protocol and interface 138 could include a matching standard USB socket and protocol. It is important to note that that if the operating system of host 130 enables host 130 to be operationally coupled to a standard data storage device that lacks special data rights management/protection functionality, host 130 need not be modified in any way to be operationally coupled to data storage device 10. Data storage device 10 appears to the operating system of host 130 as a standard data storage device that lacks special data rights management/protection functionality. On the other hand, data storage device 10 is compatible with known digital rights protection technologies and if a user desires to add further digital rights protection to data storage device 10 such addition is possible.

When data storage device 10 is connected operationally to host 130, host 130 reads file system 24 to determine how database file 40 is stored in memory 12, so that applications running on host 130 can know the identities of the blocks of memory 12 in which database file 40 is stored. (If memory 12 is a flash memory then its blocks are identified by logical block number rather than by physical block number, as is known in the prior art.) The applications running on host 130 issue block read commands to read the data in the various blocks. A detector 15 monitors the data read by host 130

All of protected information 31 that a database application will read from database file 40 is included in clusters 20a and 20c, 20d-20n. Thus protected information 31 is arranged so that a legitimate database application will not access cluster 20b and will therefore not access indicator 32a. For example, if database file 40 is a map database, all of maps accessible to the database are included in clusters 20a and 20c-20n. Since a legitimate database user will not access cluster 20b, during legitimate use of the database, host 130 will not try to access cluster 20b and legitimate use of database file 40 will not trigger a defensive response by response module 17. There may be further data available to the application in other files stored in memory 12. The other files stored memory 12 may be protected from copying or may not include copy protection.

On the other hand, if a software pirate tries to copy database file 40, the copy routine (which is unaware of the nature of the data in individual clusters of database file 40) will attempt to copy the entire database file 40. Therefore, during copying, host 130 attempts to read cluster 20b. When cluster 20b is being read detector 15 detects the access to indicator 32a and sends a message to response module 17. Accordingly response module 17 takes one or more of the defensive responses. For example,
Refuse to honor the block read commands. Stop sending data to host 130.
Issue an error message.
Issue a report of an attempt to copy protected information 31. For example, if host 130 is a cellular telephone, issue an SMS message the owner of the database.
Send spurious data to host 130 instead of real data.
Suspend the data transfer until data storage device 10 is turned off and on again.
Erase database file 40.
Erase memory 12.
Suspend access to memory 12 until it is reformatted

The defensive response may be a delayed (preferably random delay) so it will be very hard for a hacker to pinpoint what is the location of the pattern that triggered the defensive action. Not being able to pinpoint the location of indicator 32a will impede separation of indicator 32a from protected information 31 by the hacker.

In order to impede separation of protected information 31 from indicator 32a, indicator 32a is configured to have a characteristic similar to protected information 31 in clusters (20a and 20c-n). For example if clusters 20a and 20c-n contain compressed map data, then cluster 20b may also include compressed map data (the data in cluster 20b may be a copy of part of protected information 31 or cluster 20 may contain a compressed map that is not part of the database of database file 40. Thus, the characteristic compressibility of cluster 20b will be similar to the compressibility of protected information 31 in clusters 20a and 20c-n. Even if a hacker analyzes the compressibility of the data in memory 12 he will not be able to discern a difference between the data stored in cluster 20b (indicator 32a) and protected information 31 stored in clusters 20a and 20c-n.

It will be appreciated by one of ordinary skill in the art that controller 14 does not need to know the location of protected information 31. Therefore it is simple for a 3rd party to load protected information 31 to memory 12. Therefore data storage device 10 may be sold to a data provider. When preparing protected information 31 to be loaded to memory 12 a data provider adds at one or more locations clusters (for example cluster 20b) that are reported as belonging to a file but contain no useful information and contain the predefined indicator 32a.

Alternatively the manufacturer of memory 12 may preload indicator 32a onto one or more clusters (for example cluster 20b) and sell memory 12 to a software provider. The software provider then loads protected information 31 into clusters 20a and 20c-n and reports the data file as including cluster 20b.

Alternatively, detector 15 may be programmable. Thus, for added security, a data provider may tailor indicator 32a and the methodology of detection to best suits protected information 31. Furthermore, for added security, the data provider does not need to inform anybody (even the manufacturer of data storage device 10) of the location or form of indicator 32a.

The methodology presented herein may be integrated with prior art methods of digital rights management for example data encryption, digital signatures or other methods known to one of ordinary skill in the art. For example, controller 14 may include decryption functionality for decrypting files.

Alternatively, rather than protecting particular files, indicator 32a may be stored in a few locations in memory 12. For example indicator 32b is stored in a location not associated with a file. Thus, indicator 32b will only be accessed when a hacker tries to copy wholesale the entire memory 12. Thus it is possible to allow copying of any file, but not wholesale copying of the entire memory 12 (for example in the case of a game or database having special code not in one of the files controlling running of the game) by placing an indicator only in memory locations not associated to any file (similar to indicator 32b in FIG. 1). In order to avoid false alarms (and inconvenient defensive responses) detector 15 can be programmed to send a signal to response module 17 only upon detection of access to both indicators 32a and 32b. In such a case access only to indicator 32a or only to indicator 32b would not trigger a response, but when detector 15 detects access to indicator 32a and afterwards access to indicator 32b then a defensive response is triggered.

It will be understood to one of ordinary skill in the art that data storage device is suited to protecting all kinds of databases, for example a map collection, a game, executable code, a phone directory, a yellow pages, a graphics collection, a digital dictionary, a digital encyclopedia, a digital reference book or similar. It will also be understood that a host can include many different devices including for example a personal computer, a mobile phone, hand held computing device, an electronic gaming device and the like. Accordingly a data storage device can include a variety of different systems, for example a flash storage device including a disk on key or a storage card, an internal memory of the host device, a smart card, a SIM card and the like. It will also be understood that protected information 31 may be arranged to allow legitimate access (without triggering a defensive response) to one or more of a variety of applications, for example a database application, a graphics rendering application, a digital dictionary, a digital encyclopedia, a digital reference book or a navigation application

In an alternative embodiment response module 17 may be capable of undertaking many storage access responses and the particular defensive response may depend on the particular indicator detected by detector 15. Alternatively, the defensive response may depend on the number of times a particular indicator is detected or the defensive response may depend on the order in which multiple indicators are detected.

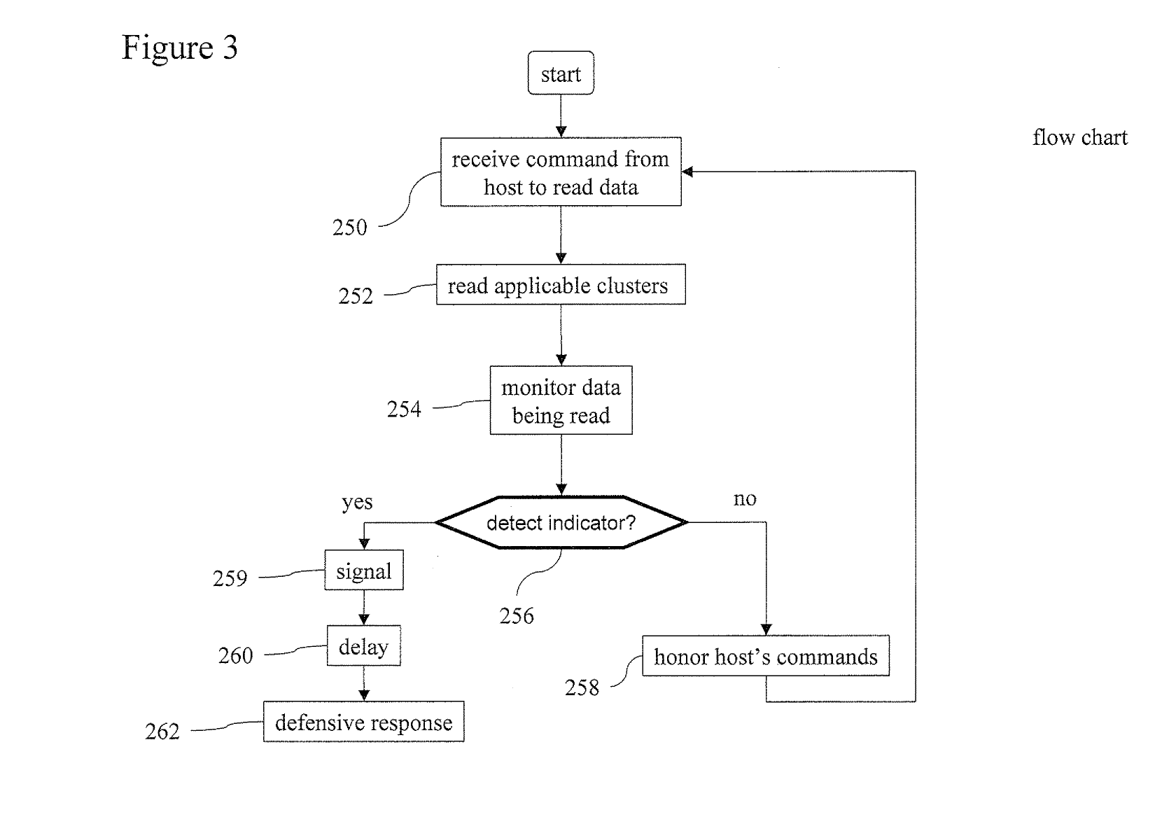

FIG. 3 is a generalized flowchart of a method of protecting information. Data storage device 10 receives (block 250) commands from host 130 to access information 31 that is stored in memory 12. Controller 14 reads (block 252) a cluster while detector 15 monitors (block 254). If indicator 32a is not detected (block 256 “no”) then data storage device 10 honors the host commands (block 258) and data storage device 10 waits to receive (block 250) further commands from host 130. On the other hand, if during monitoring (block 254) indicator 32a is detected (block 256 “yes”) then detector 15 sends a signal (block 259) to response module 17 and response module 17 waits for a delay time (block 260) and then undertakes a defensive response (block 262).

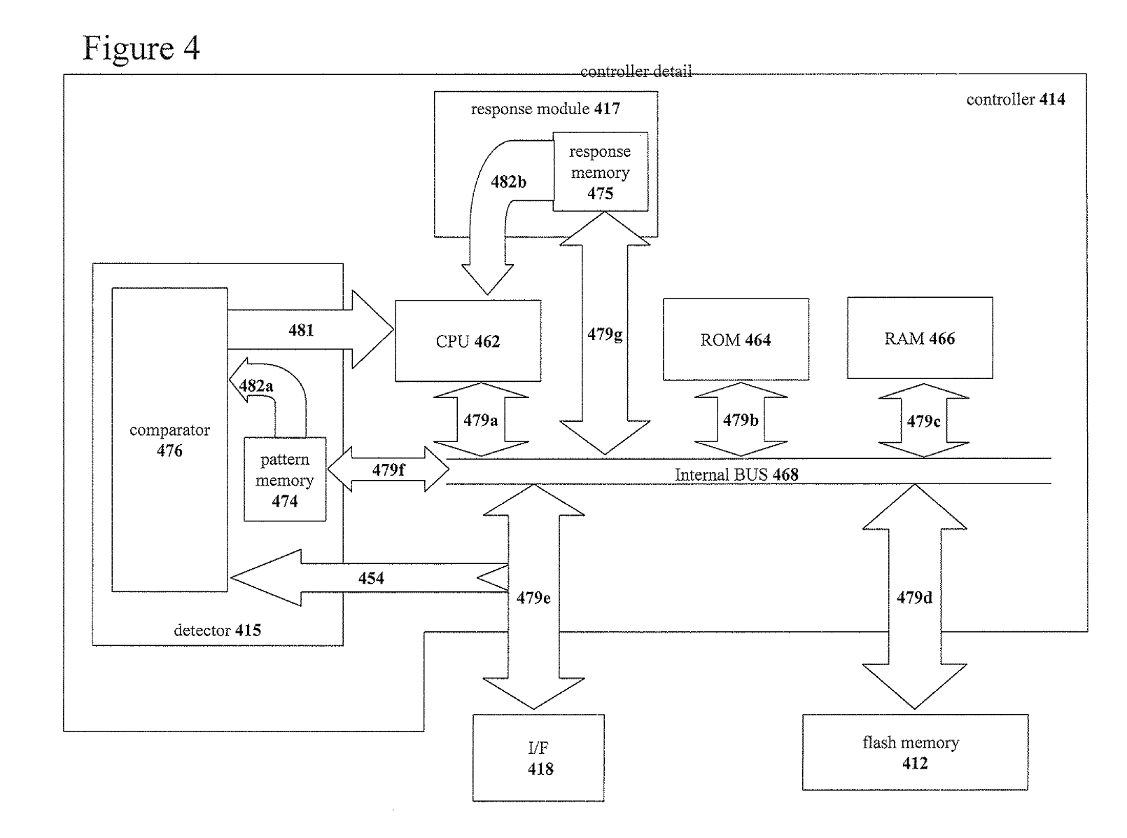

Attention is now directed to FIG. 4, a detailed high level block diagram of a storage controller 414. Storage controller 414 includes a processor CPU 462, a read only memory ROM 464 containing programming for basic functions of controller 414, a random access memory RAM 466 containing program instructions for customizable functions of controller 414, and an internal bus 468 for internal data transfer. CPU 462 ROM 464 RAM 466 and a flash memory 412 all transfer (479a-d respectively) data back and forth via internal bus 468. Controller 414 is operative to transfer 479e data stored in flash memory 412 back and forth to and from a host (not shown) over an interface 418 (for example a SD interface).

Controller 414 also includes a detector 415 and a response module 417, Detector 415 monitors 454 data that is transferred 479e across interface 418. Particularly, monitoring 454 is done by a comparator 476 which reads 482a a trigger pattern from a pattern memory 474 and compares the data being transferred 479e to the trigger pattern. If the comparison is positive (the same trigger pattern that is stored in pattern memory 474 is also being transferred 479e across interface 418) then comparator 476 sends 481 a signal to CPU 462. CPU 462 receives the signal from detector 415. CPU 462 reads 482b a stored defense response from a response memory 475 and takes the defensive response. In an alternate embodiment the defensive response or the trigger pattern may be stored in flash memory 412 in which case flash memory 412 would serve in as the pattern memory or response memory. In a further alternative embodiment, CPU 462 may be programmed to function as a comparator.

In the embodiment of FIG. 4 pattern memory 474 and response memory 475 are programmable memories (e.g. flash memories) and transfer (479f,g respectively) data back and forth with other components of controller 414 via internal bus 468. Thus the trigger pattern or defensive response may be modified. Alternatively, pattern memory 474 or response memory 475 may be ROM memories. Then the trigger pattern or defensive response may be fixed and it may be unnecessary to connect pattern memory 474 or response memory 475 to internal bus 468. In an alternative embodiment, response module 417 may include an actuator, for example a device for permanently disabling flash memory 412.

In sum, although various example embodiments have been described in considerable detail, variations and modifications thereof and other embodiments are possible. Therefore, the spirit and scope of the appended claims is not limited to the description of the embodiments contained herein.

What is claimed is:

1. A data storage device for storing information and protecting the information from copying, comprising:
a) a memory configured for storing the information and for storing an indicator integrated with the information, and
b) a detector for detecting an access to said indicator.

2. The data storage device of claim 1, further comprising:
c) a response module for undertaking a defensive response associated with said detecting.

3. The data storage device of claim 2, wherein said defensive response includes one or more of terminating access to the data storage device, disabling the data storage device, modifying at least a portion of data on the data storage device, erasing at least a portion of data in the storage device, erasing all data in the data storage device, erasing at least a part of the information, issuing a report of said accessing and sending spurious data to a host.

4. The data storage device of claim 2, wherein said response module includes at least one of a memory and an actuator.

5. The data storage device of claim 2, wherein said indicator includes a plurality of indicators and said response module is configured to undertake a first defensive response associated with detecting a first indicator of said plurality of indicators and a second defensive response associated with detecting a second indicator of said plurality of indicators.

6. The data storage device of claim 1, wherein said detector includes:
(i) a comparator, and
(ii) a memory.

7. The data storage device of claim 1, wherein said indicator includes one or more of including a trigger CRC value, including a trigger attribute and containing a trigger pattern.

8. The data storage device of claim 1, wherein said indicator is configured to impede separation of said indicator from the information.

9. The data storage device of claim 1, wherein said detector includes one or more of hardware, firmware and a combination of both hardware and firmware components.

10. The data storage device of claim 1, further comprising:
c) a standard interface for communication with a host.

11. The data storage device of claim 1, wherein said indicator includes a plurality of indicators.

12. A method of providing information to a host and of preventing copying of the information, comprising:
a) integrating an indicator with the information, and
b) storing said indicator on a data storage device, the storage device being configured to undertake a defensive response upon access to said indicator.

13. The method of claim 12, wherein said indicator includes one or more of a trigger CRC value, a trigger attribute, and a trigger pattern.

14. The method of claim 12, further comprising:
c) arranging the information and said indicator so that the information is available to an application and said indicator is inaccessible to said application.

15. The method of claim 14, wherein said application includes one or more of a database application, a graphics rendering application, a game, a digital phone book application, a digital dictionary application, a digital encyclopedia application, a digital reference book application and a navigation application.

16. The method of claim 12, wherein said undertaking a defensive response includes one or more of terminating access of the host to a memory containing the information, issuing a report of said accessing, erasing at least a part of the information, disabling a memory containing the information, erasing all data in a memory containing the information, erasing a portion of data in a memory containing the information, modifying at least a part of the information, modifying at least a portion of data in a memory containing the information, and sending spurious data to the host.

17. The method of claim 12, wherein said undertaking a defensive response is delayed.

18. The method of claim 12, further comprising:
c) configuring said indicator to impede separation of said indicator and the information.

19. The method of claim 12, further comprising:
c) supplying a standard interface for providing of the information to the host.

20. The data storage device of claim 12, wherein said indicator includes a plurality of indicators and said undertaking includes a first defensive response associated with detecting a first indicator of said plurality of indicators and a second defensive response associated with detecting a second indicator of said plurality of indicators.
